(19) United States
(12) Patent Application Publication
(10) Pub. No.: US 2013/0133261 A1
(43) Pub. Date: May 30, 2013

(54) Composite Panel and Method for Strengthening a Door Structure

(71) Applicant: Hyung Jin Choi, Valencia, CA (US)

(72) Inventor: Hyung Jin Choi, Valencia, CA (US)

(21) Appl. No.: 13/308,512

(22) Filed: Nov. 30, 2011

(51) Int. Cl. E06B 5/10; B32B 3/02

(52) U.S. Cl. 49/9; 49/506; 428/57

(57) ABSTRACT

A composite blast door, when used as an exterior door of a protected structure, can significantly decrease the risk of life threatening hazards to interior occupants. The composite blast door is composed of outer sheets of steel, intermediate sheets of fiber reinforced polymers (FRP), and a filled core of vaporized aluminum. Rubber gaskets may be used as a buffer layer between the FRP and vaporized aluminum core. Fabrication begins with a door skeleton created from steel framing elements, either hollow structural steel members or channels. Afterwards, the rear panels are attached to the door skeleton in inward order: beginning with the outer steel plate, then the FRP sheet and lastly the optional rubber gasket. The door can now be used as a form to receive the vaporized aluminum filling. After filling, the front panels are attached in the reverse order as the rear panels; rubber first, then FRP, then steel.

### FIELD OF THE INVENTION

This invention is generally related to the field of security and protection. More specifically, this invention relates to composite-material retrofits that can be applied to new and existing structures in the field to increase protection and mitigate hazards due explosive and impact forces.

### BACKGROUND OF THE INVENTION

In the event of an external force on a building by an explosive, the first elements to fail are almost always windows and doors. Typical door designs are simply inadequate to deal with the massive pressure loads experienced during blast events.

Traditional blast doors have solved this problem usually through brute force. As can be commonly seen on many older structures, massive reinforced concrete doors were used, ranging in thicknesses up to several feet. However this type of door is not feasible for daily use in a civilian environment or a temporary shelter. Nor is it cost effective when designing for less severe blast loads. For light-defense shelters, modern composite materials can be used to create alternative blast doors.

Concrete is an often used material for filling blast doors because of its ability to absorb energy. This is due to the concrete's high inertia/density as well as its ability to crush (i.e. rubblize). The high density, however, becomes a hindrance when portability and accessibility is considered. It is very difficult to dismantle and transport such a door. Most doors of this type are filled on site after assembly and left permanently. Also, the daily opening and closing of such a heavy door becomes cumbersome and many are habitually left open and unsecured.

The blast door can only be as strong as its surrounding wall. If the door is not correctly and securely attached to the supporting wall, any protection afforded by the door is negated and possibly worsened. The connections between the door and supporting wall experience massive forces during a blast. These connections, or anchors, must be designed to withstand such forces. The material of the supporting wall should be relatively rigid and stiff compared to the blast door. The ideal wall material is a thick, reinforced concrete wall or a blast panel of equal or greater blast protection rating than the blast door itself. If the wall stiffness is less than desirable, the blast door can be connected to a heavy door frame constructed of hollow steel members, which will itself be anchored to the wall. The ultimate goal is to prevent the door from escaping through the door frame and into the interior of the structure. In this scenario, the door, in effect, becomes a massive projectile. This is the most destructive, hazardous outcome possible. Of secondary importance is to ensure that the door does not fail during rebound or “bounce off” of the protected structure.

A large, or even moderate, explosion, although short in duration, can create intense loading on standing structures, and their structural elements. Most exterior doors in structures at risk for blast are still constructed of hollow metal. If this type of door was to be designed to withstand these explosive loads, it would have to be unreasonably thick. In addition, unforeseen explosion severity could create even more hazardous conditions than if the door hadn't been upgraded at all. Therefore, the solution cannot be achieved only with the bulk usage of high strength, high density materials.

Impacts upon a structure also create significantly large loads, albeit the forces are much more localized. Similar to explosive loading, the typical designs of today's door are not up to task to resist out-of-plane forces of impact loading. Extremely concentrated loads will have a tendency to create a localized failure (crack or tear) in the steel door panels before the full ductile resistance of the door can be realized. Therefore, the most feasible technology currently used for improving the blast and impact resistance of doors is with FRP composites.

A fair amount of technology currently exists for increasing existing structures' overall vulnerability to blast loads. Most strategies involve structural strengthening or hardening but the more holistic approaches involve important steps of risk mitigation. Risk mitigation usually involves developing close relationships with local law enforcement and emergency services. Some examples of structural strengthening include FRP wrapping of bridge columns and the spraying of additional concrete onto the surface of large structures. The most widely used, and arguably most cost effective, technique for structure hardening is to place sandbags as far as possible from the building perimeter and on the roofs of a structure. Unfortunately, this is often impractical for routine use or not possible due to the configuration of the structure. In cases where increased standoff is impossible, a part of structural hardening must include the security of all entryways and entrance points into a structure. These points are building locations which are most vulnerable to explosive event. Furthermore, in severe instances, the explosive threat is contained inside the structure as is the case with chemical facilities which houses energetic materials. In these cases, having secure blast doors on the exterior and interior of the facility may be required.

There is a prevalent need for a method of strengthening structures for explosive and impact forces.

### SUMMARY OF THE INVENTION

An objective of the invention is to provide a composite panel for strengthening a door against an external force.

Another objective of the invention is to provide a method of strengthening a door against an external force.

In order to achieve the objectives, the present invention provides a composite panel for strengthening a door against an external force. The composite panel comprises a first exterior layer, a second exterior layer, an energy absorbing layer that is provided between the first exterior layer and the second exterior layer and a perimeter frame that supports the first exterior layer, the energy absorbing layer and the second exterior layer in their perimeters. The energy absorbing layer comprises low density energy absorbing material that absorbs mechanical energy by collapsing.

The composite panel may further comprise a first strengthening layer that has high tensile strength and high ductility in the direction of the plane of the first strengthening layer. The first strengthening layer is provided between the first exterior layer and the energy absorbing layer.

The composite panel may further comprise a first intermediate layer that disperses the external force in the plane of the first intermediate layer. The first intermediate layer is provided between the first strengthening layer and the energy absorbing layer.

The composite panel may further comprise a second strengthening layer that has high tensile strength and high ductility in the direction of the plane of the second strengthening layer. The second strengthening layer is provided between the second exterior layer and the energy absorbing layer.

The composite panel may further comprise a second intermediate layer that disperses the external force in the plane of the second intermediate layer. The second intermediate layer is provided between the second strengthening layer and the energy absorbing layer.

Preferably, the energy absorbing material comprises vaporized aluminum.

The thickness of each of the first exterior layer, the first strengthening layer, the first intermediate layer, the second exterior layer, the second strengthening layer, and the second intermediate layer is less than a predetermined layer thickness. Preferably, the predetermined layer thickness is about 0.25 inch.

The first and second exterior layers are made of steel. The first and second intermediate layers are made of rubber. Each of the first strengthening layer and the second strengthening layer comprises a plurality of reinforcing fiber fabric sheets and a polymer matrix in which the reinforcing fiber fabric sheets are suspended.

The composite panel may further comprise a mechanical fastening device that fastens the first exterior layer, the first strengthening layer, the first intermediate layer, the energy absorbing layer, the second exterior layer, the second strengthening layer, and the second intermediate layer together. Preferably, the mechanical fastening device comprises a plurality of rivets applied with predetermined interval on the surface of the first exterior layer and the second exterior layer.

The present invention also provides a strengthened door assembly comprising a composite panel, a door frame, which is adapted to be fixed to a building structure, and an opening and closing device enabling pivoting of the composite panel with respect to the door frame, and latching the composite panel to the door frame.

The opening and closing device comprises a hinge and a door latch. The load bearing capacity of the hinge and the door latch is bigger than the load bearing capacity of the composite panel.

The overlap between the edge of the composite panel and the edge of the door frame is bigger than a predetermined overlap length. Preferably, the predetermined overlap length is about 2 inches.

The present invention also provides a method for strengthening a door panel assembly against an external force. The method comprises steps of transferring of the external force exerted on an exterior layer of the door assembly to an energy absorbing layer of the door panel assembly; and absorbing energy with deformation of the energy absorbing layer. The energy absorbing layer comprises low density energy absorbing material that absorbs mechanical energy by collapsing.

The method may further comprise a step of transferring of the external force to a strengthening layer that has high tensile strength and high ductility in the direction of the plane of the strengthening layer, before the step of absorbing energy.

The method may further comprise a step of transferring of the external force to an intermediate layer that disperses the external force in the plane of the intermediate layer, before the step of absorbing energy.

The method may further comprise step of supporting the door panel assembly on a door frame. The door frame has load bearing capacity bigger than the load bearing capacity of the door panel assembly, whereby the door panel assembly is deformed before the door frame is deformed.

The present invention is summarized again with its advantageous effects.

The present invention is a composite blast door that replaces exterior doors of temporary or permanent structures to improve their protection to explosive and impact forces. Applicable structures include buildings, factories, storehouses, tunnels and almost any wall of acceptable stiffness and blast resistance.

The present invention utilizes vaporized aluminum, otherwise known as aluminum foam. Aluminum foam is a lightweight, ductile material that can be manipulated into absorbing massive amounts of energy. Aluminum closed-cell foams have high energy absorbance and are primarily used as an impact-absorbing material, similar to polymer foams but suitable for much higher impact loads. They are lightweight and stiff; and therefore, frequently proposed as a structural material. In addition, they are fire resistant, fully recyclable, non toxic, have low thermal conductivity, have low magnetic permeability, and have excellent sound dampening. They also have much better weathering properties than polymer foams when considering UV light, humidity and temperature. They can be manufactured in density ranges 10-25% the density of solid aluminum in accordance with strength demands. Most importantly, they are quickly becoming cheap to mass produce.

The composite blast door is composed of a steel skeleton constructed from tubes or channels, two sheets of structural steel plate, two layers of pre-made two-dimensional FRP, a filling of vaporized aluminum and two optional rubber gaskets. Each layer of FRP will contain 2-6 sheets of reinforcing fiber fabric suspended in a polymer matrix and be around 0.125 inches thick. The separating rubber gaskets will be around 0.25 inches thick. Total thickness of the composite blast door should be around 2.5 inches. Any common reinforcing fibers may be used (e.g. glass, carbon and aramid). The sheets of fiber fabric, otherwise known as fiber preforms, can be created through common textile techniques, such as knitting, braiding, stitching and weaving. Preforms are typically woven with openings between fibers in the range of 0.05 inches to 1 inch. The polymer matrix that is almost always used is epoxy but there are some alternatives such as vinylester and polyester thermosetting plastic. The preferred fiber to be used is Kevlar, an aramid fabric produced by DuPont which is known for its high strength and resistance to heat while still remaining cost effective. The type of fiber, type of matrix, weave density and weave orientation can all be adjusted to achieve a desired combination of stiffness, tensile strength and cost.

The installation of the composite panel is relatively straightforward. The rear steel sheet is attached to the steel skeleton. Then the rear FRP layer, which is slightly smaller than the steel plate is attached to the interior of the rear plate, or simply installed wet. After the FRP cures, the optional rubber gasket can be attached, if desired, by adhesive to the FRP. The door is now ready to be used as a form and filled with vaporized aluminum. After the filling is installed, the front rubber and FRP layers are installed in the reverse order. Finally, the front steel sheet is attached with adhesive to the front FRP layer whilst being attached mechanically to the steel frame. If desired, multiple rivets can be employed along the face of the entire door at some specified spacing to ensure that the separate layers are bonded (i.e to supplement the adhesive).

Because the composite blast door is relatively lightweight and portable, it can be installed on a variety of structures. Although the ideal application is a reinforced concrete structure, the panel is equally effective on portable field structures.

Most polymers decompose into toxic fumes when exposed to fire. This risk is minimized because all FRP and rubber layers are completely enclosed within the steel sheets. However, to minimize any risk, it is strongly recommended that the exposed surface of the composite blast door be covered with fire-resistant paint. If it is preferable, an inherently fire-resistant FRP (e.g. silicone-fiberglass) can be employed.

The composite panel is pre-fabricated in shop. This allows the present invention to be installed much more quickly than concrete filled blast doors which have to be constructed on-site. The installation of the present invention is also much less technical. It requires no special training involved with high-strength concrete, only the ability to install concrete anchors and assemble hinges. The short installation time combined with the low difficulty of installation will dramatically lower labor costs. This is especially advantageous when dealing with inconsistent labor or reinforcing existing structures that are inhabited.

The method of the present invention is applicable to new and existing buildings without making them extremely cumbersome and inaccessible. Sensitive buildings which require protection must have a required degree of blast safety while still be able to operate smoothly and efficiently without excessive disturbances. The protected structure should have healthy sound structural walls to resist anchor loads from the blast door. It must also have multiple entry/exit points to allow evacuation of any personnel or energetic materials. Of equal importance, the blast door must not create unnecessary hazards for blast events with unforeseen severity. Neglecting progressive collapse, flying debris is the most deadly consequence of an explosive event. Of secondary importance, the design should be easily constructed of globally available materials. Furthermore, the designed retrofit should be able to be installed by typically trained contractors using basic construction techniques. The present invention satisfies these stringent requirements.

The invention will now be described in greater detail. It is implied that there are many modifications and variations possible for the present invention. The invention may be utilized in ways other than as specifically described if it is within the scope of the appended claims.

### BRIEF DESCRIPTION OF THE DRAWINGS

The accompanying drawings illustrate the best embodiments of the present invention. In the drawings:

FIG. 1 is a cross-section view of a composite blast door of the present invention showing details of its separate layers;

FIG. 2 is an exploded cross-section view of the composite blast door to clearly differentiate between the separate layers;

FIG. 3 is a perspective view of the composite blast door installed on the exterior wall of a reinforced concrete structure;

FIG. 4 is an exploded perspective view of the composite blast door showing the main components and the order of fabrication;

FIG. 5 is a cross-section view of a strengthening layer;

FIG. 6 is a cross-section view of the composite blast door installed at a door frame; and

FIG. 7 is a flow diagram of a method for resisting blast at a door.

### DETAILED DESCRIPTION OF THE INVENTION

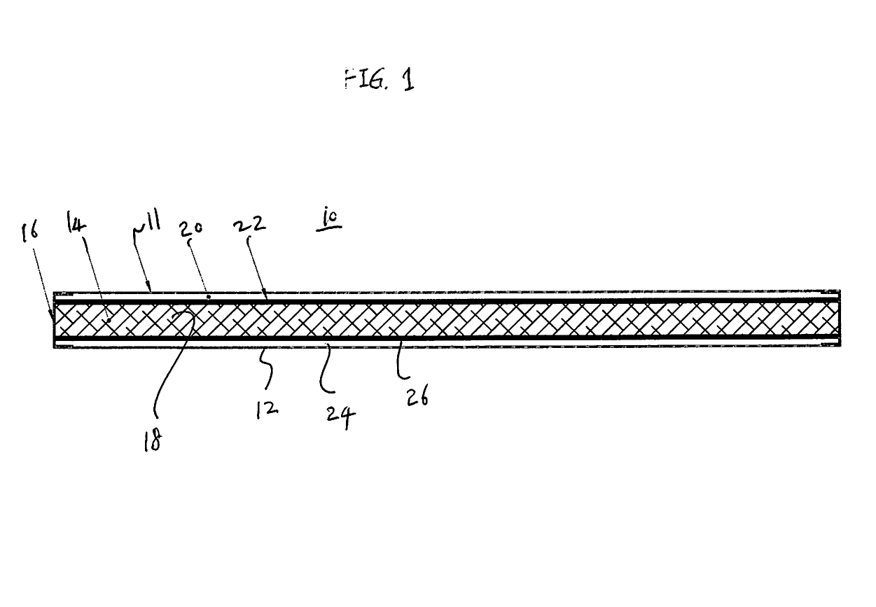

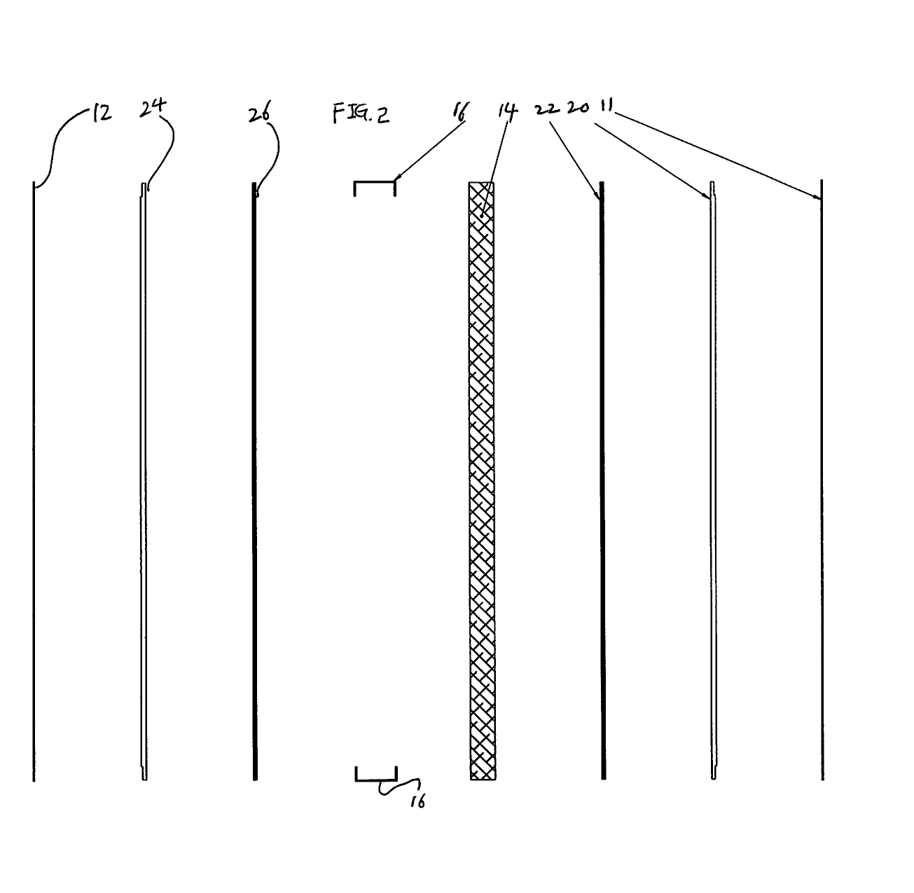

FIGS. 1 and 2 show a composite panel 10 for strengthening a door against an external force. The composite panel 10 comprises a first exterior layer 11, a second exterior layer 12, an energy absorbing layer 14 that is provided between the first exterior layer 11 and the second exterior layer 12 and a perimeter frame 16 that supports the first exterior layer 11, the energy absorbing layer 14 and the second exterior layer 12 in their perimeters. The energy absorbing layer 14 comprises low density energy absorbing material 18 that absorbs mechanical energy by collapsing.

The composite panel 10 further comprises a first strengthening layer 20 that has high tensile strength and high ductility in the direction of the plane of the first strengthening layer. The first strengthening layer 20 is provided between the first exterior layer 11 and the energy absorbing layer 14.

The composite panel 10 further comprises a first intermediate layer 22 that disperses the external force in the plane of the first intermediate layer. The first intermediate layer 22 is provided between the first strengthening layer 20 and the energy absorbing layer 14.

The composite panel 10 further comprises a second strengthening layer 24 that has high tensile strength and high ductility in the direction of the plane of the second strengthening layer. The second strengthening layer 24 is provided between the second exterior layer 12 and the energy absorbing layer 14.

The composite panel 10 further comprises a second intermediate layer 26 that disperses the external force in the plane of the second intermediate layer. The second intermediate layer 26 is provided between the second strengthening layer 24 and the energy absorbing layer 14.

Preferably, the energy absorbing material 18 comprises vaporized aluminum.

The thickness of each of the first exterior layer 11, the first strengthening layer 20, the first intermediate layer 22, the second exterior layer 12, the second strengthening layer 24, and the second intermediate layer 26 is less than a predetermined layer thickness. Preferably, the predetermined layer thickness is about 0.25 inch.

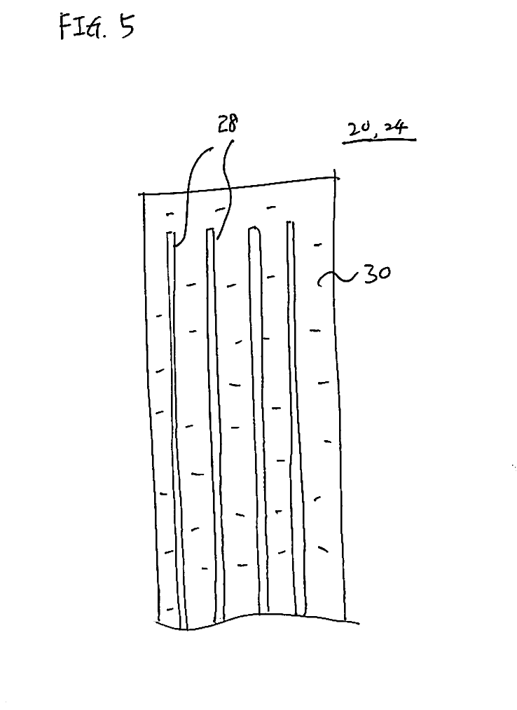

The first and second exterior layers 11, 12 are made of steel. The first and second intermediate layers 22, 26 are made of rubber. FIG. 5 shows that each of the first strengthening layer 20 and the second strengthening layer 24 comprises a plurality of reinforcing fiber fabric sheets 28 and a polymer matrix 30 in which the reinforcing fiber fabric sheets 28 are suspended.

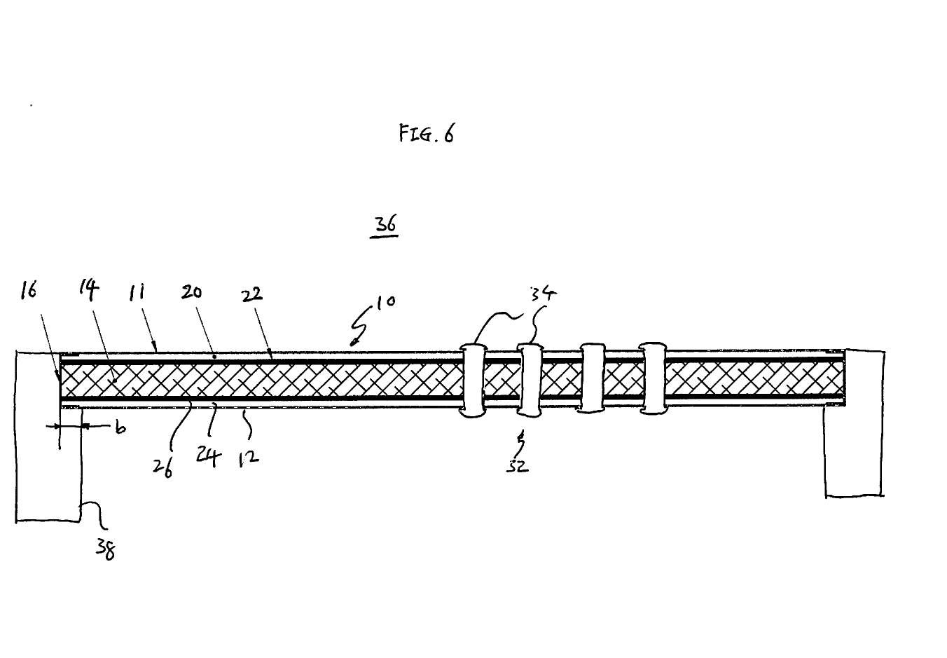

FIG. 6 shows that the composite panel further comprises a mechanical fastening device 32 that fastens the first exterior layer 11, the first strengthening layer 20, the first intermediate layer 22, the energy absorbing layer 14, the second exterior layer 12, the second strengthening layer 24, and the second intermediate layer 26 together. The mechanical fastening device 32 comprises a plurality of rivets 34 applied with predetermined interval on the surface of the first exterior layer 11 and the second exterior layer 12. The rivets are illustrated larger than scale for clarity.

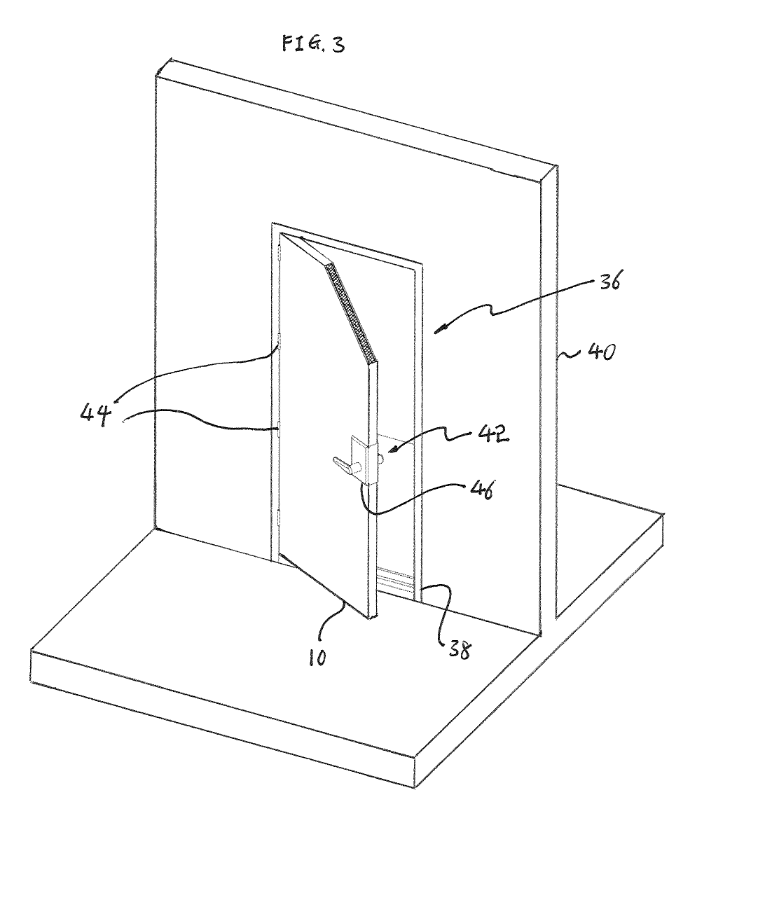

FIGS. 3 and 6 show a strengthened door assembly 36 comprising the composite panel 10, a door frame 38, which is adapted to be fixed to a building structure 40, and an opening and closing device 42 enabling pivoting of the composite panel 10 with respect to the door frame 38, and latching the composite panel 10 to the door frame 38.

The opening and closing device 42 comprises hinges 44 and a door latch 46. The load bearing capacity of the hinge 44 and the door latch 46 is bigger than the load bearing capacity of the composite panel 10.

The overlap b between the edge of the composite panel 10 and the edge of the door frame 38 is bigger than a predetermined overlap length. Preferably, the predetermined overlap length is about 2 inches.

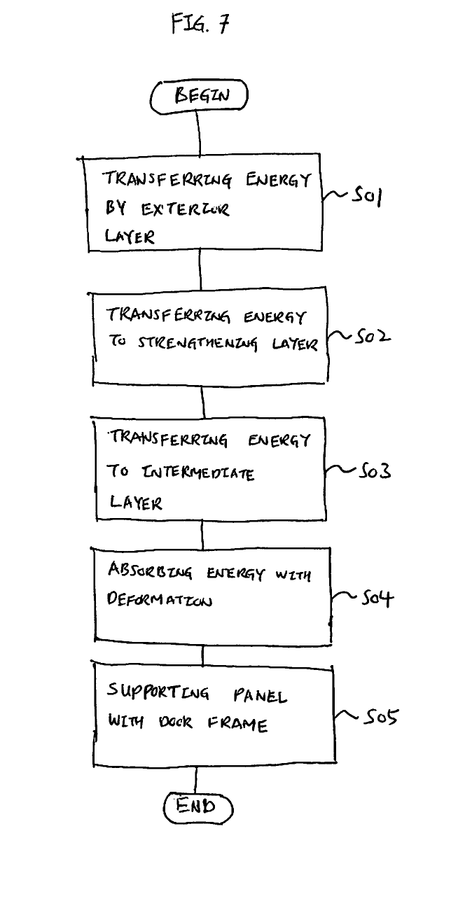

FIG. 7 shows a method for strengthening a door panel assembly against an external force. The method comprises step S01 of transferring of the external force exerted on an exterior layer of the door assembly to an energy absorbing layer of the door panel assembly; and step S04 of absorbing energy with deformation of the energy absorbing layer. The energy absorbing layer comprises low density energy absorbing material that absorbs mechanical energy by collapsing.

The method further comprises a step S02 of transferring of the external force to a strengthening layer that has high tensile strength and high ductility in the direction of the plane of the strengthening layer, before the step of absorbing energy.

The method further comprise a step S03 of transferring of the external force to an intermediate layer that disperses the external force in the plane of the intermediate layer, before the step of absorbing energy.

The method may further comprise step S05 of supporting the door panel assembly on a door frame. The door frame has load bearing capacity bigger than the load bearing capacity of the door panel assembly, whereby the door panel assembly is deformed before the door frame is deformed.

The present invention is described again with its advantageous effects.

The present invention is a composite blast door 10 and the method for its installation. The composite blast door is used for protecting structures such as bases and factories from the hazards related to explosive and impact loads. The potential loads can be anticipated from the explosion of energetic materials (e.g. petroleum products, steam, chemicals, terrorist attacks) and from the impact of massive objects (e.g. ballistics, munitions, vehicles, terrorist attacks). FIG. 3 is an isometric view of the blast door 10 being installed onto a wall 40.

The composite blast door includes a steel door skeleton 16, two sheets of steel 11, 12, two layers 20, 24 of fiber-reinforced polymers, two optional layers 22, 26 of rubber gaskets and a filling of vaporized aluminum 18. The use of FRP allows the composite blast door to be lightweight yet still have very high tensile strength. Therefore, the addition of composite blast doors to a structure mitigates the risk of injury and possible fatalities.

Because the composite blast door uses pre-made layers of FRP, there are many more types of polymer matrixes that can be used. There is no stringent demand that the polymer must adhere to the applied surface or that it must cure in the field. Therefore, a polymer can be chosen based on cost and mechanical properties alone. This will allow the best performing, most cost-effective polymer to be used.

It is generally preferred that both layers of FRP be composed of the same polymer matrix. This allows two layers to have identical thermal expansion, hardness and general chemical nature. If sufficiently compatible, two different types of polymer matrixes can be used on unique applications. The preferred reinforcing-fiber in the FRP panels is DuPont's Kevlar para-aramid fabric. This is due to Kevlar's ability to absorb greater amounts of energy when compared to carbon or glass fibers. If an application requires higher strength rather than toughness, carbon fibers can easily be substituted instead. Glass fibers are not preferable unless cost or scale is a paramount priority, as its physical characteristics are less desirable than other common reinforcing fibers. Lastly, other uncommon fibers (e.g. nylon, polyester, cotton, wool, linen, silk, synthetic spider silk) may be used as needed for special applications. The reinforcing fiber is made into cloth much like other textiles. It can be woven, knit or braided. Different types of fibers may also be combined together into a single fabric to create a combination of properties. If adhesion to the polymer matrix is a problem, the fabric preform can be treated with a coupling agent, such as a monomolecular layer of polysiloxane. The openings between yarns in the fabric are in the range of 0.05 inches to 1 inch across. The orientation of fibers in a woven cloth can intersect at any angle, though the most common angles are 90° and 45°. Furthermore, it may be advantageous to have different fibers going in different orientations. For example, a fabric preform may have Kevlar fibers in the vertical direction and carbon fibers in the horizontal direction. Fiber type, weave density and weave orientation are altered to achieve an optimal combination of elongation, stiffness, tensile strength and cost. Each sheet/layer of FRP should contain from 2-6 sheets of fabric performs, each of which can be identical or distinct.

The addition of rubber gaskets is optional with the use of two-dimensional FRP. Two-dimensional FRP is a laminated structure in which the fibers are only aligned along the plane in the x and y-direction of the material. In other words, there are no fibers aligned through the thickness of the material, or in the z-direction. Two major problems arising from the use of two-dimensional FRP are a decrease in through-thickness mechanical properties and poor impact damage tolerance. This means that the FRP used in the present invention is particularly weak under out-of-plane loads and is susceptible to localized ruptures, or tears. This poses a problem with crushable fill material which has the potential of creating sharp edges or shards. When a sharp piece of debris from the vaporized aluminum fill strikes the first layer of FRP, it will create a force on a very small area, producing huge pressures that can locally breach the FRP. The problem is alleviated by the rubber gasket which will disperse the force over a larger area on the FRP layer. Therefore, the more dispersed loading onto the layer of FRP should ensure that the composite blast door does not experience a local rupture.

It is essential that the layers of FRP, rubber, or steel in the composite blast door are no more than 0.25 inches thick per layer. This is because the effectiveness of the panel depends on the combination of properties from the different layers of the composite. In other words, during an explosive event, the blast load should interact with the composite blast door as a whole; not with the first layer of steel first and the FRP soon afterward.

Polymers typically shrink as they cure. This should be kept in mind when fabricating the pre-made FRP panels. The panels should be formed slightly bigger and thicker than the final dimensions. This effect is not a major issue when FRP is not being field applied, but the shrinking should be noted. Before installation of the composite panel is started, the steel panel with which it is to be attached should be fairly clean. Any sign of sharp edges or dusted texture on the surface should be reduced as much as possible. Generally, it is not necessary to apply a primer to the steel before application of the first layer of FRP but an adhesive may be used to aid with fabrication.

The composite blast door will typically be pre-fabricated as a whole unit and shipped in entirety. However, if the situation permits, the blast door may be assemble in the field. The layers of steel, FRP, rubber gasket may also be bonded together with mild adhesive to facilitate in the process of field assembly. For example, a blast door can be assembled by a single contractor using conventional bolts or welding usually within a single work day.

The bite of a blast door shall be defined as the overlap between the edge of the door 10 and the edge of the retaining door frame 38. It is best to have the largest bite possible as this gives the blast door less chance of escaping the frame and being projected into the structure. Often, adjacent walls and obstructions limit the amount of bite possible. In these cases, the minimum bite around the entire door should be at least 2 inches.

When installing the blast doors, heavy duty hinges 44 and latches 46 should be incorporated into the initial design. The hardware used for the blast door must be blast rated to withstand larger loads than the blast door, itself. This will ensure that the blast door will always fail before the associated hardware. Industrial hinges are classified according to load rating and a series of heavy-gauge steel hinges should be adequate. As of recently, many door latch manufacturers produce high-strength latches that are specifically designed to withstand blast loads. With the increasing popularity of specialty door hardware, prices are rapidly becoming reasonable.

Most polymers and textiles are flammable and toxic when burned. Therefore, it is necessary to increase the fire-resistance of any FRP used on an occupied structure. For most composites, including the most widely used polyurethane/glass combination, fire-resistance is increased by adding fire-resistant paint over the exposed surface. This method is not advised as our FRP is not directly exposed to the environment and the paint may have adverse affects on the adhesive. The feasible alternative would be to paint the exterior of the blast door, itself. If painting is not possible, the FRP can be created with fire-resistant additives inserted into the polymer matrix. The additive most often used is an intumescent powder. Lastly, if the additive is cost prohibitive, the FRP layer can be replaced with a FRP that is inherently fire-resistant. The most common inherently fire-resistant FRP is a silicone elastomer with glass fibers.

Similarly, the FRP panel may be protected from ultraviolet light in much the same way. An ultraviolet resistant paint can be employed or additives can be added into the polymer matrix of the second layer of FRP.

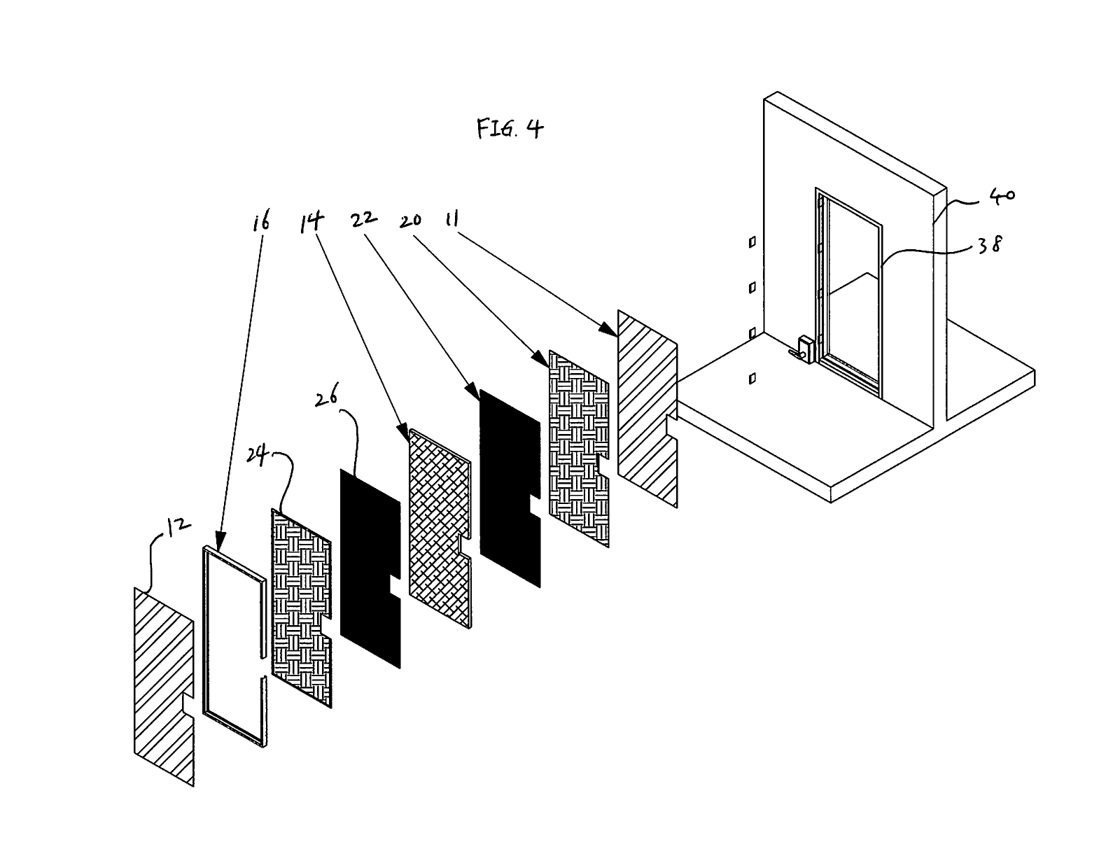

FIG. 4 shows the details of the separate layers for the composite blast door. The size of FRP layers should be at least 2 inches shorter in length and width than the clear space between the steel skeleton. The rubber gasket will separate the FRP from the vaporized aluminum filling and have the same dimensions as the FRP layers. The steel sheets will be sized identically to the steel skeleton and will be mechanically attached to it by means of conventional bolts or continuous welding. The blast door will be secured to the supporting door frame by means of heavy-gauge hinges and blast-rated latches.

This invention has been described with reference to certain specific embodiments. However, it is to be understood that modifications and substitutions can be made by an engineer without departing from the scope thereof.

I claim:

1. A composite panel for strengthening a door against an external force, wherein the composite panel comprises:
a) a first exterior layer;
b) a second exterior layer;
c) an energy absorbing layer that is provided between the first exterior layer and the second exterior layer; and
d) a perimeter frame that supports the first exterior layer, the energy absorbing layer and the second exterior layer in their perimeters;
wherein the energy absorbing layer comprises low density energy absorbing material that absorbs mechanical energy by collapsing.

2. The composite panel of claim 1, further comprising a first strengthening layer that has high tensile strength and high ductility in the direction of the plane of the first strengthening layer, wherein the first strengthening layer is provided between the first exterior layer and the energy absorbing layer.

3. The composite panel of claim 2, further comprising a first intermediate layer that disperses the external force in the plane of the first intermediate layer, wherein the first intermediate layer is provided between the first strengthening layer and the energy absorbing layer.

4. The composite panel of claim 3, further comprising a second strengthening layer that has high tensile strength and high ductility in the direction of the plane of the second strengthening layer, wherein the second strengthening layer is provided between the second exterior layer and the energy absorbing layer.

5. The composite panel of claim 4, further comprising wherein a second intermediate layer that disperses the external force in the plane of the second intermediate layer, wherein the second intermediate layer is provided between the second strengthening layer and the energy absorbing layer.

6. The composite panel of claim 5, wherein the energy absorbing material comprises vaporized aluminum.

7. The composite panel of claim 5, wherein the thickness of each of the first exterior layer, the first strengthening layer, the first intermediate layer, the second exterior layer, the second strengthening layer, and the second intermediate layer is less than a predetermined layer thickness.

8. The composite panel of claim 7, wherein the predetermined layer thickness is about 0.25 inch.

9. The composite panel of claim 8, wherein the first and second exterior layers are made of steel, wherein the first and second intermediate layers are made of rubber, wherein each of the first strengthening layer and the second strengthening layer comprises a plurality of reinforcing fiber fabric sheets and a polymer matrix in which the reinforcing fiber fabric sheets are suspended.

10. The composite panel of claim 9, further comprising a mechanical fastening device that fastens the first exterior layer, the first strengthening layer, the first intermediate layer, the energy absorbing layer, the second exterior layer, the second strengthening layer, and the second intermediate layer together.

11. The composite panel of claim 10, wherein the mechanical fastening device comprises a plurality of rivets applied with predetermined interval on the surface of the first exterior layer and the second exterior layer.

12. A strengthened door assembly comprising:
a) a composite panel;
b) a door frame, wherein the door frame is adapted to be fixed to a building structure;
c) an opening and closing device enabling pivoting of the composite panel with respect to the door frame, and latching the composite panel to the door frame;
wherein the composite panel comprises:
i) a first exterior layer;
ii) a second exterior layer;
iii) an energy absorbing layer that is provided between the first exterior layer and the second exterior layer; and
iv) a perimeter frame that supports the first exterior layer, the energy absorbing layer and the second exterior layer in their perimeters;
wherein the energy absorbing layer comprises low density energy absorbing material that absorbs mechanical energy by collapsing.

13. The door assembly of claim 12, wherein the opening and closing device comprises a hinge and a door latch, wherein the load bearing capacity of the hinge and the door latch is bigger than the load bearing capacity of the composite panel.

14. The door assembly of claim 13, wherein the overlap between the edge of the composite panel and the edge of the door frame is bigger than a predetermined overlap length.

15. The door assembly of claim 14, wherein the predetermined overlap length is about 2 inches.

16. A method for strengthening a door panel assembly against an external force, the method comprising steps of:
a) transferring of the external force exerted on an exterior layer of the door assembly to an energy absorbing layer of the door panel assembly; and
b) absorbing energy with deformation of the energy absorbing layer;
wherein the energy absorbing layer comprises low density energy absorbing material that absorbs mechanical energy by collapsing.

17. The method of claim 16, further comprising a step of transferring of the external force to a strengthening layer that has high tensile strength and high ductility in the direction of the plane of the strengthening layer, before the step of absorbing energy.

18. The method of claim 17, further comprising a step of transferring of the external force to an intermediate layer that disperses the external force in the plane of the intermediate layer, before the step of absorbing energy.

19. The method of claim 18, further comprising step of supporting the door panel assembly on a door frame, wherein the door frame has load bearing capacity bigger than the load bearing capacity of the door panel assembly, whereby the door panel assembly is deformed before the door frame is deformed.
